(19) United States
(12) Patent Application Publication
(10) Pub. No.: US 2015/0034012 A9
(43) Pub. Date: Feb. 5, 2015

(54) ANIMAL FEEDER

(71) Applicants: Hazel Clarke, Bundall (AU); Joseph Clarke, Bundall (AU)

(72) Inventors: Hazel Clarke, Bundall (AU); Joseph Clarke, Bundall (AU)

(21) Appl. No.: 13/712,332

(22) Filed: Dec. 12, 2012

(30) Foreign Application Priority Data
Dec. 14, 2011 (AU) 2011905220

(51) Int. Cl. A01K 5/00

(52) U.S. Cl. CPC A01K 5/00
USPC 119/51.01

(57) ABSTRACT

An animal feeder for facilitating oral hygiene includes a body having a support wall for supporting food for an animal. A plurality of tongue scraping formations project away from the support wall for scraping a tongue of the animal when the animal licks the tongue scraping formations on the support wall.

### FIELD

This invention relates to animal oral hygiene. More particularly, but not exclusively, this invention relates to an animal feeder and to a method for facilitating oral hygiene.

### SUMMARY

Various exemplary embodiments of the invention provide an animal feeder for facilitating oral hygiene, the animal feeder comprising:

a body having a support wall for supporting food for an animal; and

a plurality of tongue scraping formations projecting away from the support wall for scraping a tongue of the animal when the animal licks the tongue scraping formations on the support wall.

The tongue scraping formations may be arranged on part of the support wall to define a tongue scraping zone within which the tongue scraping formations are located. The tongue scraping formations may be arranged on the support wall to define a plurality of tongue scraping zones within which associated tongue scraping formations are located.

The tongue scraping formations may be arranged on the support wall to define an elongated tongue scraping zone that extends centrally across the support wall of the body of the animal feeder.

The support wall may define a guide formation for guiding an animal's tongue while the animal is licking. In particular, the guide formation may be oriented to guide the animal's tongue into engagement with the tongue scraping zone. The guide formation may be in the form of a recessed support wall portion and the tongue scraping zone may at least partly coincide with the recessed support wall portion so that at least some of the tongue scraping formations are located on the recessed support wall portion. The recessed support wall portion may be defined centrally at least partly across the support wall. The recessed support wall portion may include a narrowed or converging portion that is oriented so that an animal's tongue can be guided into engagement with the tongue scraping zone.

The tongue scraping formations may be configured so that food tends to get stuck between the formations. This encourages licking and enhances the cleaning effect. Furthermore, salivation is also encouraged, leading to improved oral health. The size of the tongue scraping formations may vary depending on the amount of licking activity required and the size of animal, such as a dog, for which the feeder finds application. It will be appreciated that the size and configuration of the tongue scraping formations can determine how difficult it will be for the animal to retrieve food that becomes stuck between the tongue scraping formations. The more difficult it is, the more the animal will lick, resulting in an increased salivation and cleaning effect. One of the dimensions that can be varied is the height of each tongue scraping formation. For example, the tongue scraping formations can be between 1 mm and 4 mm high. These dimensions can vary depending on the result required. Another of the dimensions that can be varied is a width of the recessed support wall portion that will need to accommodate the size of the animal, particularly the animal's tongue.

In one exemplary embodiment, the tongue scraping formations may be arranged to form a tongue scraping zone that is elongated to extend across the support wall. The tongue scraping zone may have a width that at least partly converges transversely towards a central part of the support wall.

At least some tongue scraping formations may be elongated, triangular-prism shaped formations, and may be positioned on the support wall so that a base is fixed to the support wall and an opposite elongated sharp edge or apex extends generally parallel to the base.

The triangular-prism shaped formation may have a lengthwise dimension of between 4 mm and 10 mm, for example 5 mm, and the base may have a transverse dimension of between 1 mm and 5 mm, for example 1.5 mm or 2.6 mm, and major side faces may have a transverse width or height of between 1 mm and 5 mm, for example 2 mm or 2.9 mm.

At least some of the tongue scraping formations may be arranged in rows so that their apices are in various orientations relative to each other. The rows may be spaced between 5 mm and 15 mm apart, for example about 8.5 mm apart in one exemplary embodiment and about 10 mm apart in another exemplary embodiment.

At least part of the support wall that is excluded from the tongue scraping zone may include a plurality of spaced apart protuberances, such as semi-spherical formations, that project away from the support wall. The semi-spherical formations may have a radius of curvature of between 1 mm and 5 mm, and at least some of the semi-spherical formations may be spaced apart between 5 mm and 15 mm, for example 7.5 mm or 10 mm, from each other.

The tongue scraping formations may be oriented relative to each other to facilitate scraping of the animal's tongue from different directions. The tongue scraping formations may be arranged so that apices of at least some adjacent tongue scraping formations are lengthwise misaligned, for example at right angles to each other.

The body may be formed from a synthetic plastics material. In one embodiment, the tongue scraping formations may be formed from a relatively softer material and a rest of the body may be formed from a relatively harder material. The tongue scraping zone that defines the tongue scraping formations may be formed from a resiliently flexible plastics material such as a thermoplastic rubber. The rest of the body may be formed from a thermoplastic polymer, such as polypropylene.

Thus, in one exemplary embodiment, a part of the support wall which defines the tongue scraping zones and the tongue scraping formations may be formed from a relatively softer material than a rest of the body of the animal feeder. The relatively softer material may be a thermoplastic polymer such as polypropylene.

The invention further provides a dog feed bowl for facilitating oral hygiene, the dog feed bowl including a tongue scraper for scraping a tongue of the animal when the animal licks the tongue scraping formations of the dog feed bowl.

The dog feed bowl may include any one or more of the optional features in accordance with the above aspects of the invention, and as herein defined, described, and illustrated.

Exemplary embodiments of the invention are described with reference to the accompanying drawings in the following description. As such, the following description is for illustrative purposes only and is not intended to narrow the scope of the preceding paragraphs or the appended claims.

### BRIEF DESCRIPTION OF THE DRAWINGS

FIG. 1 shows a three-dimensional view of an exemplary embodiment of an animal feeder.

FIG. 2 shows a top plan view of the animal feeder.

FIG. 3 shows a detailed top plan view of an exemplary embodiment of a floor and sidewall of the animal feeder.

FIG. 4 shows a sectioned view taken across A-A in FIG. 5.

FIG. 5 shows a top plan view of an exemplary embodiment of an animal feeder.

FIG. 6 a detailed top plan view of an exemplary embodiment of a central portion of a floor of the animal feeder.

FIG. 7 shows an expanded view of the area A in FIG. 4.

FIG. 8 shows an expanded view of the area B in FIG. 4.

FIG. 9 shows part of a support wall with tongue scraping formations in an exemplary arrangement.

FIG. 10 shows a sectioned view taken across A-A in FIG. 9.

FIG. 11 shows a top plan view of an exemplary embodiment of an animal feeder.

FIG. 12 shows an expanded view of the area A in FIG. 8.

FIG. 13 shows an expanded view of the area B in FIG. 8.

FIG. 14 shows a detailed top plan view of an exemplary embodiment of a floor and sidewall of an animal feeder.

### DETAILED DESCRIPTION OF THE DRAWINGS

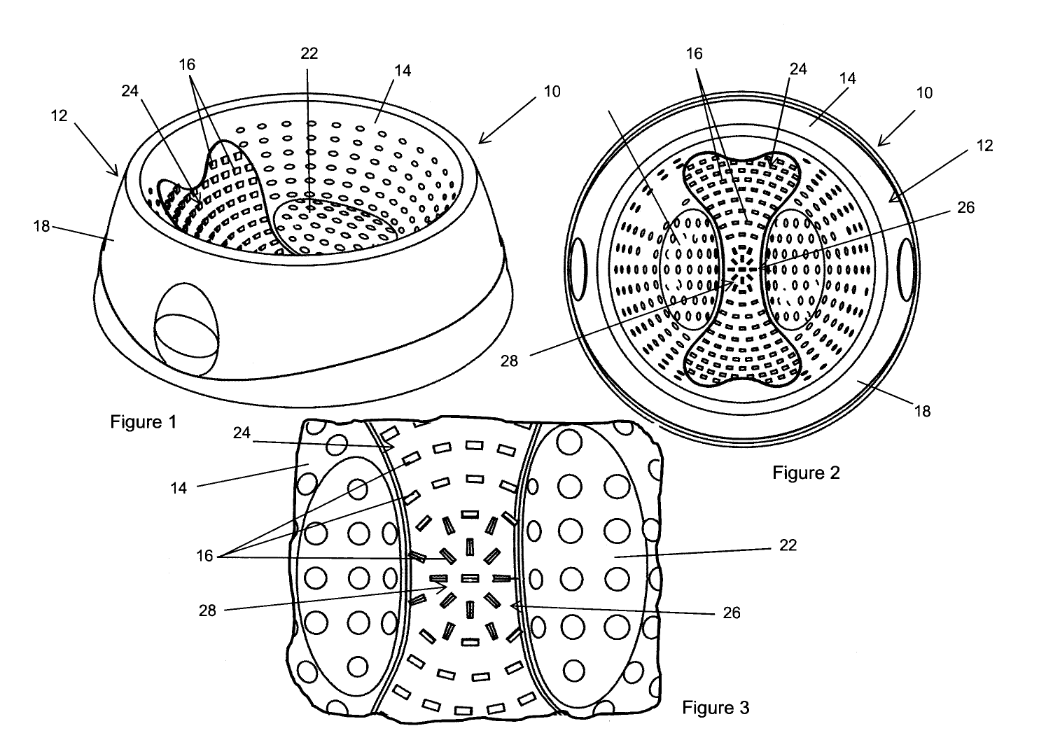

In FIG. 1, reference numeral 10 generally indicates an exemplary embodiment of an animal feeder for facilitating oral hygiene. In one example, the animal feeder 10 is in the form of a dog feed bowl that includes a body 12 having a support wall 14 for supporting food for the dog. The dog feed bowl 10 also includes a plurality of tongue scraping formations 16 that are provided on the support wall 14 for scraping a tongue of the dog when the dog licks the tongue scraping formations 16 on the support wall 14 of the dog feed bowl 10. The inventor(s) envisages that the tongue scraping formations 16 can readily be provided for any other form of dish or receptacle for use in feeding animals, for example, domestic animals. Thus, the tongue scraping formations 16 can be provided on a support wall of a cat dish, a domestic trough, or any other such receptacle for feeding different animals.

The body 12 includes an outer wall 18. The outer wall 18 can be generally frusto-conically shaped. The support wall 14 can include a central portion or hub 22 from which the rest of the support wall 14 radiates toward an upper edge of the outer wall 18.

The tongue scraping formations 16 are provided on part of the support wall 14 and are arranged to form a tongue scraping zone, generally indicated by reference numeral 24. The tongue scraping zone 24 is elongated and can extend across the support wall 14 of the dog feed bowl 10. The tongue scraping zone 24 can converge transversely towards the hub 22. The tongue scraping zone 24 can be shaped to depict an item. For example, the tongue scraping zone 24 can have curved ends so as to depict a symbolic bone, as illustrated in the drawings.

The support wall 14 defines a recessed support wall portion 26 that extends across the hub 22, and a central part of the tongue scraping zone 24 coincides with the recessed support wall portion 26 in an area where the tongue scraping zone 24 converges or is narrowed. The convergence or narrowing of the recessed support wall portion 26 encourages or guides licking of the zone 24 in a particular direction. For example, the animal will be encouraged to lick along the tongue scraping zone 24 instead of across the narrowed portion. Thus, the tongue engages the tongue scraping zone 24 for a maximum amount of time.

The body 12 can be formed from a synthetic plastics material. In this embodiment that part of the body 12 that defines the tongue scraping zone 24 and the tongue scraping formations 16 can be formed from a relatively softer material such a thermoplastic rubber or an elastomeric material. The rest of the body 12 can be formed from a relatively harder material such as a thermoplastics material, for example polypropylene or polyethylene. It is also envisaged that the body 12 can be in the form of a one-piece moulding.

The tongue scraping formations can have an overall height of between 1 mm and 2 mm.

The tongue scraping formations 16 can be in the form of elongated triangular-prism shaped formations, and are positioned on the support wall with their elongated bases fixed to the support wall 14. Opposite elongated sharp edges or apices can extend generally parallel to associated bases.

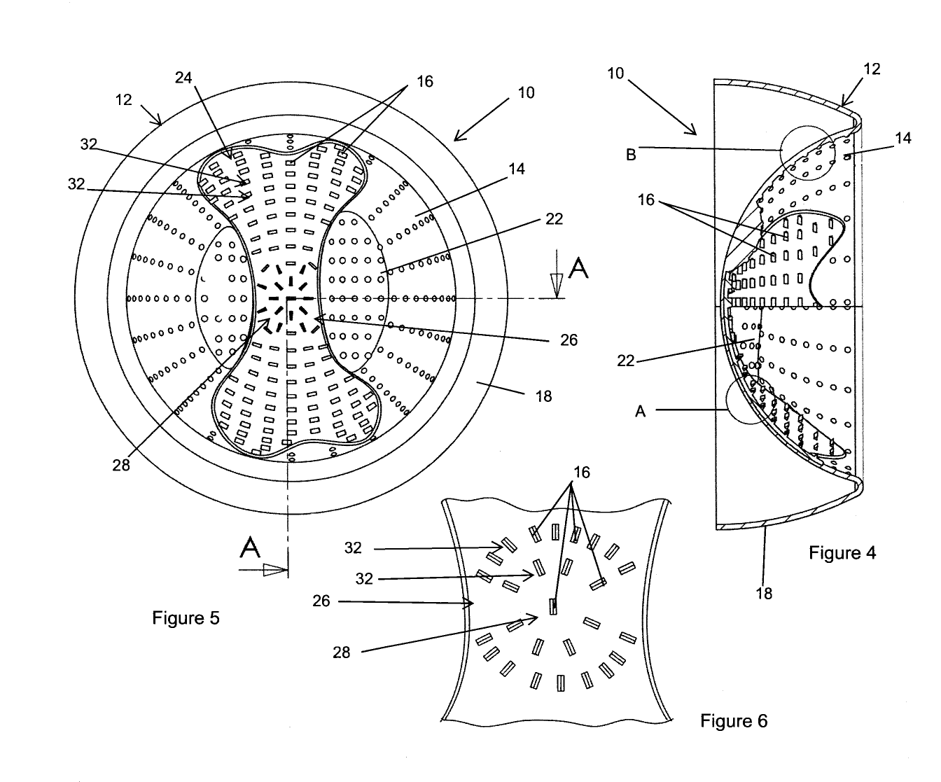

FIG. 8 shows a magnified view of a part A (FIG. 4) of the tongue scraping zone 24 which shows the triangular-prism shaped formations 16 spaced apart (b) by about 8.5 mm, having bases (a) of about 1.5 mm, and having major side faces with a transverse dimension or height (c) of about 2 mm. The inventor(s) envisages that the dimensions (a), (b) and (c) can vary by up to 50% in one example.

The tongue scraping formations 16 are arranged relative to each other to facilitate scraping of the animal's tongue from different directions. One exemplary embodiment of an arrangement of the tongue scraping formations 16 is illustrated in FIG. 3. In this exemplary embodiment, the tongue scraping formations 16 are arranged to include a central formation 28 surrounded by spaced formations 30 that are arranged on a pitch circle and which radiate lengthwise outwardly. Rows 32 of formations 16 are arranged on part pitch circles or contours of the support wall 14. The inventor(s) envisages that the formations 16 can be arranged in a number of other configurations so that they achieve a tongue scraping effect when an animal licks the zone 24. For example, as shown in FIG. 9, the tongue scraping formations 16 are arranged in consecutive, differing orientations along each row 32. One example is a difference of 90° between consecutive tongue scraping formations 16. The inventor(s) envisages that the difference can be any amount from 0° to 90°. Furthermore, the difference or variation need not be consistent. For example, two consecutive tongue scraping formations 16 can differ by about 90° while a further two consecutive tongue scraping formations 16 can differ by, for example, 45°. In other words, the inventor(s) envisages that the relative orientations of consecutive tongue scraping formations 16 can be random.

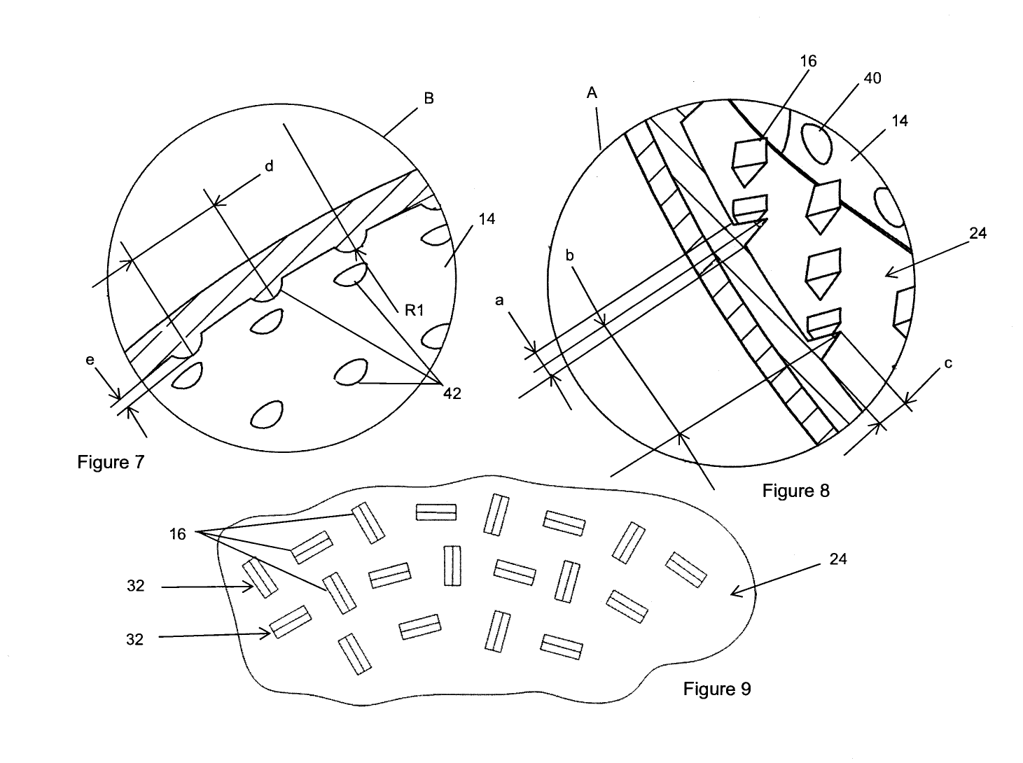

In this regard, FIG. 6 shows another exemplary embodiment of an arrangement of the tongue scraping formations 16. As can be seen, the successive rows 32 are also arranged on part pitch circles or contours of the support wall 14. Here, the formations 16 are arranged longitudinally and radially with respect to a central formation 16. In other words, the formations 16 radiate longitudinally and outwardly from a centre.

The configuration of the tongue scraping formations 16 together with their dimensions can be selected to achieve desirable results with dogs, for example. For example, the tongue scraping formations 16 can be configured to make it more difficult for the dog to gain access to food stuck between the formations 16. This can increase licking activity and thus salivation and cleaning due to scraping of the tongue against the formations 16. The increased salivation can help to kill bacteria and germs within the oral cavity, thereby countering halitosis.

The rest of the support wall 14 includes a plurality of spaced apart protuberances in the form of semi-spherical knobs 40 that are arranged on the hub 22 and also in outwardly radiating rows 42. These can also provide a cleaning effect and can increase salivation. The knobs 42 can also be aligned along common contours about the support surface 14.

FIG. 7 is an illustrative, magnified view of a part B of an exemplary support wall 14 which includes the bulbous or semi-spherical knobs or projections 42. The knobs 42 shown in FIG. 7 are about 7.5 mm apart (d) between common contours and, when semi-spherical, have a radius (R1) of curvature of about 1.5 mm. The knobs 42 have a height (e) of about 1 mm. The inventor(s) envisages that the dimensions d, e and R1 can vary by up to about 50% in one example.

FIG. 14 illustrates an exemplary embodiment of an arrangement of the tongue scraping formations 16. In that embodiment, the formations 16 are arranged in a plurality of rows 32 on part contours of the support wall 14 of the dog feed bowl 44. As can be seen in this exemplary embodiment, instead of the central formation 28 surrounded by spaced formations 30 arranged in a lengthwise, radiating fashion, the formations 16 are arranged in rows 32 along contours of the support wall 14. The inventor(s) envisages that this arrangement can be used with any exemplary feeders. As can be seen, the formations 16, in this exemplary embodiment, are arranged transversely with respect to a licking direction that is encouraged by the orientation of the recessed portion 26.

The inventor(s) envisages that instead of a recessed portion, per se, the portion 26 can be defined by a pair of bulbous or swollen sections indicated by a line 27 in FIG. 14.

The feed bowl 10 includes tongue scraping formations 16 for scraping a tongue of an animal to reduce build-up of bacteria, fungi, food debris, and the like, on the animal's tongue. This can reduce risks of oral health problems and halitosis. The tongue scraping formations 16 can also serve to encourage salivation, which is understood to improve oral health.

The feed bowl 10 includes tongue scraping formations 16 that are oriented relative to each other to facilitate scraping of the animal's tongue from more than one licking direction. For example, where the tongue scraping formations 16 are oriented as shown in FIG. 9, the animal's tongue can be scraped while the animal licks in two or more directions.

The recessed support wall portion 26 can collect part of the food and can guide the animal's tongue into operative engagement with the tongue scraping formations 16 within the recessed support wall portion 26, to facilitate scraping of the animal's tongue. A part of the recessed support wall portion 26 can be shaped to have an aesthetically pleasing appearance, such as that which symbolises a dog bone.

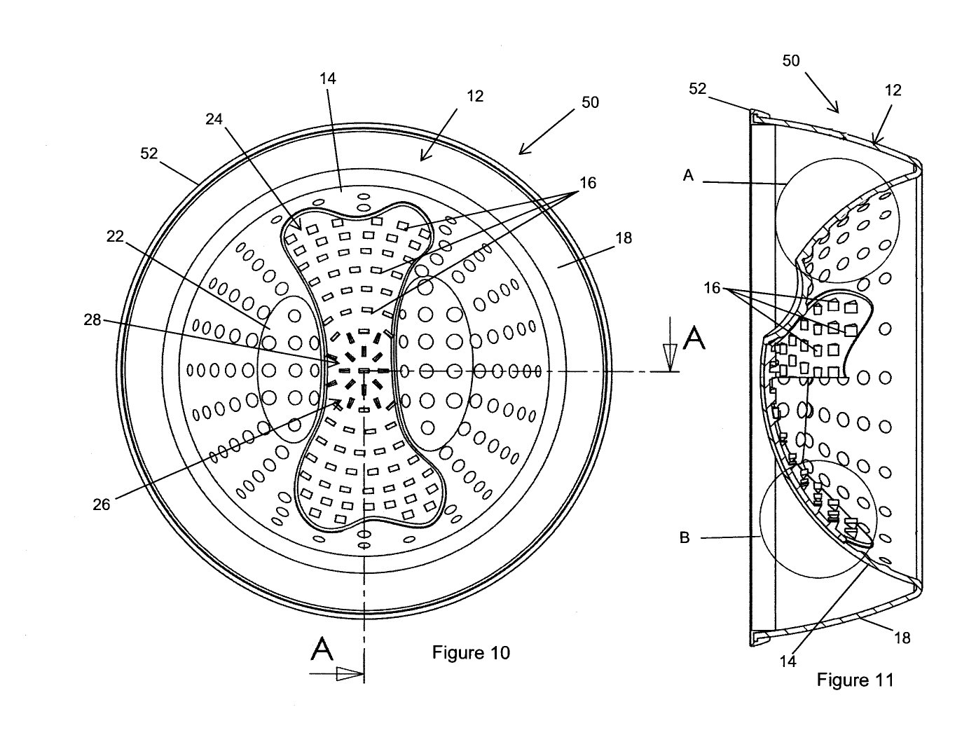

In FIGS. 10 and 11, reference numeral 50 generally indicates another embodiment of an animal feeder or dog bowl, in accordance with the invention. With reference to the preceding drawings, like reference numerals refer to like parts, unless otherwise specified.

The dog bowl 50 is similar to the dog bowl 10. However, it has a smaller overall size and has differently sized formations 16. These are illustrated in FIG. 13 which is a magnified view of the part B in FIG. 11. The formations 16 can have an overall height (h) of about 2.9 mm and can be spaced apart (f) by about 10 mm. They have a transverse dimension or thickness (g) of about 2.6 mm. The inventor(s) envisages that the dimensions f, g, h can be varied by up to 50%, in one example.

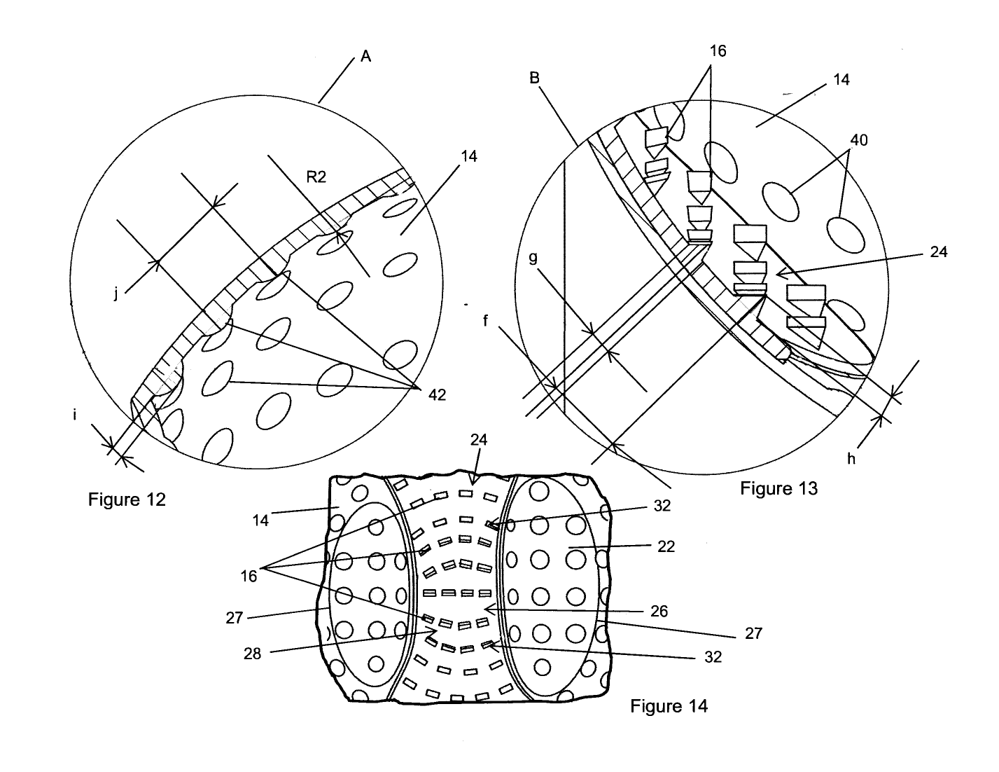

FIG. 12 is a magnified, illustrative view of the part A in FIG. 11. In that exemplary embodiment, the protuberances or projections 40, 42 have a radius (R2) of about 3.8 mm, when semi-spherical, and are spaced (j) about 10 mm apart between common contours. The protuberances 42 have a height (i) of about 0.9 mm. The inventor(s) envisages that the dimensions f, g, h, i, R2 can be varied by up to 50%, in one example.

In use, the food can become lodged between the formations 16 in the recessed portion 26 encouraging the animal to spend time licking that area in an attempt to get at the food. This can enhance salivation and cleaning of the animal's tongue. The inventor(s) envisages that the recessed portion 26 can have any particular shape and may also have dimensions to suit a particular sized animal, for example a dog, which would usually be associated with the size of the bowl 10.

Still further, the tongue scraping formations 16 are formed from a relatively softer material than a rest of the dog feed bowl 10 to reduce the risk of injury to the dog's tongue when it licks the tongue scraping formations 16. For example, the relatively softer material can be an elastomeric material such as a food grade elastomeric material, polyurethane or the like.

The feeder 50 can include a ring 52 arranged peripherally about a free edge of the outer wall 18 to bear against a support surface. The ring 52 can be of a material selected to enhance frictional engagement of the feeder 10 with the support surface. For example, the ring can be of the same material as the tongue scraping zone 24, that is, a thermoplastic rubber.

Throughout the specification, including the claims, where the context permits, the term “comprising” and variants thereof such as “comprise” or “comprises” are to be interpreted as including the stated integer or integers without necessarily excluding any other integers.

Various substantially and specifically practical and useful exemplary embodiments of the claimed subject matter, are described herein, textually and/or graphically, including the best mode, if any, known to the inventors for carrying out the claimed subject matter. Variations (e.g., modifications and/or enhancements) of one or more embodiments described herein might become apparent to those of ordinary skill in the art upon reading this application. The inventors expect skilled artisans to employ such variations as appropriate, and the inventors intend for the claimed subject matter to be practiced other than as specifically described herein. Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:

there is no requirement for the inclusion of any particular described or illustrated characteristic, function, activity, or element, any particular sequence of activities, or any particular interrelationship of elements;

no characteristic, function, activity, or element is “essential”;

any elements can be integrated, segregated, and/or duplicated;

any activity can be repeated, any activity can be performed by multiple entities, and/or any activity can be performed in multiple jurisdictions; and

any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Moreover, when any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

It is to be understood that the terminology employed above is for the purpose of description and should not be regarded as limiting. The described embodiments are intended to be illustrative of the invention, without limiting the scope thereof. The invention is capable of being practiced with various modifications and additions as will readily occur to those skilled in the art.

1. An animal feeder for facilitating oral hygiene, the animal feeder comprising:
a body having a support wall for supporting food for an animal; and
a plurality of tongue scraping formations projecting away from the support wall for scraping a tongue of the animal when the animal licks the tongue scraping formations on the support wall.

2. An animal feeder as claimed in claim 1, in which the tongue scraping formations are arranged on part of the support wall to define at least one tongue scraping zone within which the tongue scraping formations are located.

3. An animal feeder as claimed in claim 2, in which the tongue scraping formations are arranged on the support wall to define an elongated tongue scraping zone that extends centrally across the support wall of the body of the animal feeder.

4. An animal feeder as claimed in claim 3, in which the support wall defines a recessed support wall portion and the tongue scraping zone at least partly coincides with the recessed support wall portion so that at least some of the tongue scraping formations are located on the recessed support wall portion.

5. An animal feeder as claimed in claim 4, in which the recessed support wall portion is defined centrally at least partly across the support wall.

6. An animal feeder as claimed in claim 4, in which the recessed support wall portion defines a narrowed portion so that a tongue of an animal is guided into engagement with the tongue scraping zone.

7. An animal feeder as claimed in claim 1, in which at least a number of the tongue scraping formations are elongated, triangular-prism shaped formations, and are positioned on the support wall with a base fixed to the support wall and an opposite elongated sharp edge or apex extending generally parallel to the base.

8. An animal feeder as claimed in claim 7, in which each triangular-prism shaped formation has a lengthwise dimension of between 4 mm and 10 mm and the base has a transverse dimension of between 1 mm and 5 mm, and major side faces have a transverse width or height of between 1 mm and 5 mm.

9. An animal feeder as claimed in claim 7, in which a number of the tongue scraping formations are arranged in rows so that their apices are in various orientations relative to each other.

10. An animal feeder as claimed in claim 9, in which the tongue scraping formations are arranged so that apices of at least some adjacent tongue scraping formations are lengthwise misaligned.

11. An animal feeder as claimed in claim 10, in which rows of tongue scraping formations are spaced between 5 mm and 15 mm apart.

12. An animal feeder as claimed in claim 3, in which at least part of the support wall that is excluded from the tongue scraping zone includes a plurality of spaced apart protuberances that project away from the support wall.

13. An animal feeder as claimed in claim 12, in which the protuberances are semi-spherical formations with a radius of curvature of between 1 mm and 5 mm.

14. An animal feeder as claimed in claim 13, in which a number of the semi-spherical formations are spaced between 5 mm and 15 mm apart from each other.

15. An animal feeder as claimed in claim 1, in which the body is formed from a synthetic plastics material.

16. An animal feeder as claimed in claim 15, in which the tongue scraping formations are formed from a relatively softer material than a rest of the body.

17. An animal feeder as claimed in claim 16, in which the tongue scraping formations are formed from a resiliently flexible plastics material such as a thermoplastic rubber while the rest of the body is formed from a thermoplastic polymer, such as polypropylene or polyethylene.
